(19) United States
(12) Patent Application Publication
(10) Pub. No.: US 2017/0052491 A1
(43) Pub. Date: Feb. 23, 2017

(54) IMAGE FORMING APPARATUS

(71) Applicant: CANON KABUSHIKI KAISHA, Tokyo (JP)

(72) Inventor: Kenichi Hirota, Joso-shi (JP)

(21) Appl. No.: 15/233,609

(22) Filed: Aug. 10, 2016

(30) Foreign Application Priority Data
Aug. 17, 2015 (JP) 2015-160540

(51) Int. Cl. G03G 15/00

(52) U.S. Cl. CPC G03G 15/50

(57) ABSTRACT

An image forming apparatus includes a toner image forming unit, a transfer member, and a driving source. An execution unit corrects image misalignment on the basis of a detection result of a test one image when no toner image exists in a transfer portion. An input unit associates first and second containers of recording material with either first and second groups regarding characteristics of the recording material. A setting is possible in which, if the recording material stored in the container associated with the first and second groups is used for the image formation, the driving source is driven at first and second speeds. Whether to conduct the correction before the current image formation is determined depending on the group associated with the container in which the recording material on which the previous image formation is conducted is stored.

### BACKGROUND OF THE INVENTION

Field of the Invention

The present invention relates to an image forming apparatus, such as a printer and a digital multifunction imaging apparatus.

Description of the Related Art

Regarding image forming apparatuses especially for business use, there exists a demand for a higher level of image property (i.e., color stability and reduction in image roughness) of images printed on a sheet as a recording material recently. The image property at a high level is demanded in a wide range of media, from thin paper of about 50 gsm of basic weight used for, for example, printing flyer or direct mail, to a cardboard of about 400 gsm used for, for example, package printing.

Especially in an electrophotographic image forming apparatus, in order to stably transfer a printing image from an image bearing member to a sheet, images are formed independently in each color and the formed color images are registered on an intermediate transfer member (a belt or a roller) (primary transfer). The registered image is then secondarily transferred to the sheet finally (a secondary transfer system).

Since a disturbance factor caused by the physical properties of the sheet during registration of the colors can be eliminated by the intermediate transfer member, the secondary transfer system is advantageous in easily obtaining stable image transferabilty compared with a direct transfer system in which colors are registered directly on the sheet.

In order to enable an image forming apparatus of the secondary transfer system to print on various types of sheets, an external secondary transfer belt is desirably used at a portion at which an image is transferred from the intermediate transfer member to the sheet. This is because the external secondary transfer belt provides high transferability also when a sheet with unevenness on its surface, such as embossed paper, is used, or provides improved sheet conveyance property in the secondary transfer portion since it is possible to stick the sheet to the external secondary transfer belt with bias charge during transfer.

When the external secondary transfer belt is used, since the sheet substantially sticks to the external secondary transfer belt, the conveyance speed of the sheet is substantially the same as the surface velocity of the external secondary transfer belt. Since the sheet is conveyed sticking to the external secondary transfer belt, the conveyance speed of the sheet is determined by the surface velocity of the belt with substantially small fluctuation. Therefore, stable image magnification is obtainable by driving the external secondary transfer belt at a constant speed.

The sheet conveyance speed is stabilized by driving the external secondary transfer belt at a constant speed, however, a speed difference is caused due to a small difference in the curvature radius inside a secondary transfer nip between the intermediate transfer member and the sheet surface. In order to make the sheet surface velocity the same as the surface velocity of the intermediate transfer member, the driving speed of the external secondary transfer belt needs to be controlled optimally depending on the type of the sheet.

Japanese Patent Laid-Open No. 2008-281931 discloses preparing a driving source for an intermediate transfer member and a driving source for a secondary transfer member independently, and adjusting the speed of a secondary transfer member depending on the thickness of a sheet so as to cancel a change in the circumferential speed accompanying a speed change produced on a sheet circumferential surface caused by the thickness of the sheet.

In an image forming apparatus required to enable to print on various types of sheet media, from thin paper to broad cardboard, there exist the optimal setting values of various surface velocities of the external secondary transfer belt depending on the corresponding sheet. That is, it is necessary to change the driving speed of the external secondary transfer belt whenever the sheet setting is changed and, therefore, mechanical load to the intermediate transfer member changes each time.

If it is estimated that the mechanical load to the intermediate transfer member may vary, registered images are printed on the intermediate transfer member as patches, which are measured and fed back again to imaging start timing, an amount of magnification, and the like of each color as automatic registration control. Alignment for each color is conducted in this manner. Automatic registration control generally needs to be conducted whenever the mechanical state changes (mainly torque variation caused by changes in surface properties of the intermediate transfer member due to temperature rise or durable situation of the apparatus).

If the driving speed of the external secondary transfer belt is to be set optimally depending on each of all the corresponding sheet thicknesses, a series of operations of patch printing, patch detection and measurement, cleaning, and the like becomes necessary due to frequent execution of the automatic registration control. This may cause considerably long downtime.

### SUMMARY OF THE INVENTION

According to an aspect of the present invention, an image forming apparatus includes:

a toner image forming unit configured to form a toner image on an intermediate transfer member;

a conveyance member configured to form a transfer portion with the intermediate transfer member via a recording material at which the toner image formed on the intermediate transfer member is transferred to the recording material, and configured to convey the recording material to the transfer portion;

a driving source configured to apply driving force to the conveyance member independently of an intermediate transfer member driving source which applies driving force to the intermediate transfer member;

a correction execution unit configured to execute a correction operation to correct timing at which the toner image is formed on the basis of a detection result of a test toner image formed on the intermediate transfer member in a period in which no toner image exists in the transfer portion;

a plurality of containers in which the recording material to be conveyed to the transfer portion is stored;

an input unit using which an operator makes input to associate each of the plurality of containers and a thickness or a basic weight of the recording material, and input to set a mode in which, in a continuous image formation job in which formation of toner images on a plurality of recording materials is conducted continuously, the driving source is driven at a speed determined on the basis of a thickness or a basic weight of a recording material used for each image formation event and each image formation event is conducted; and

an execution unit which, if the mode is set, in each image formation event in the continuous image formation job, the driving source is driven at a first speed and image formation is conducted in the case of image formation using a recording material included in a first group, and the driving source is driven at a second speed lower than the first speed and image formation is conducted in the case of image formation using a recording material included in a second group, wherein the execution unit divides each recording material corresponding to the plurality of containers into the first group and the second group so that the thickness or the basic weight of all the recording materials included in the first group are smaller than the thickness or the basic weight of all the recording materials included in the second group and, if the recording material used in the previous image formation and the recording material used in the current image formation are included in the same group, the current image formation is conducted without conducting the correction operation. and, if the recording material used in the previous image formation and the recording material used in the current image formation are included in the different groups, the correction operation is conducted before conducting the current image formation, and the current image formation is conducted at timing at which a toner image is formed after the correction.

According to another aspect of the present invention, an image forming apparatus includes:

a toner image forming unit configured to form a toner image on an intermediate transfer member;

a conveyance member configured to form a transfer portion with the intermediate transfer member via a recording material at which the toner image formed on the intermediate transfer member is transferred to the recording material, and configured to convey the recording material to the transfer portion;

a driving source configured to apply driving force to the conveyance member independently of an intermediate transfer member driving source which applies driving force to the intermediate transfer member;

a plurality of containers in which the recording material to be conveyed to the transfer portion. is stored;

an input unit using which an operator makes input to associate each of the plurality of containers and a thickness or a basic weight of the recording material, input to set a mode in which, in a continuous image formation job in which formation of toner images on a plurality of recording materials is conducted continuously, the driving source is driven at a predetermined speed irrespective of a thickness and a basic weight of a recording material used for each image formation event and each image formation event is conducted, and

input to set, if the mode is set, to either of a plurality of settings including a first setting in which the predetermined speed is set to the first speed and a second setting in which the predetermined speed is set to a second speed lower than the first speed; and

an execution unit which, if the mode is set, drives the driving source at the predetermined speed and executes image formation in each image formation event in the continuous image formation job.

According to an aspect of the present invention,

an image forming apparatus includes:

a toner image forming unit configured to form a toner image on an intermediate transfer member;

a conveyance member configured to form a transfer portion with the intermediate transfer member via a recording material at which the toner image formed on the intermediate transfer member is transferred to the recording material, and configured to convey the recording material to the transfer portion;

a driving source configured to apply driving force to the conveyance member independently of an intermediate transfer member driving source which applies driving force to the intermediate transfer member;

a correction execution unit configured to execute a correction operation to correct timing at which the toner image is formed on the basis of a detection result of a test toner image formed on the intermediate transfer member in a period in which no toner image exists in the transfer portion;

a plurality of containers in which the recording material to be conveyed to the transfer portion is stored;

an input unit using which an operator makes input to associate each of the plurality of containers and a thickness or a basic weight of the recording material, and an input unit in which, in a continuous image formation job in which a plurality of image formation events are conducted continuously, an operator conducts input for setting a first mode in which the driving source is driven at a speed determined on the basis of a thickness or a basic weight of a recording material used for each image formation event, and conducts each image formation event, and

input for setting a second mode in which the driving source is driven at a predetermined speed not on the basis of the thickness and the basic weight of the recording material used for each image formation event in the continuous image formation job in which a plurality of image formation events are conducted continuously, and conducts each image formation event;

an execution unit which, if the first mode is set, in each image formation event in the continuous image formation job, the driving source is driven at a first speed and image formation is conducted in the case of image formation using a recording material included in a first group, and the driving source is driven at a second speed lower than the first speed and image formation is conducted in the case of image formation using a recording material included in a second group, wherein the execution unit divides each recording material corresponding to the plurality of containers into the first group and the second group so that the thickness or the basic weight of all the recording materials included in the first group are smaller than the thickness or the basic weight of all the recording materials included in the second group and,

if the second mode is set, in the continuous image formation job, the driving source is driven at the predetermined speed and each image formation event is conducted irrespective of the thickness and the basic weight of the recording material used for each image formation event.

Further aspects and features of the present invention will become apparent from the following description of exemplary embodiments with reference to the attached drawings.

### BRIEF DESCRIPTION OF THE DRAWINGS

FIG. 1 is a cross-sectional view of an image forming apparatus according to an embodiment of the present invention.

FIG. 2A is a cross-sectional view of a secondary transfer portion according to an embodiment of the present invention. FIG. 2B is a partially enlarged view of the secondary transfer portion.

FIG. 3 is a system block diagram according to an embodiment of the present invention.

FIGS. 4A to 4D are diagrams illustrating a medium setting screen of an image forming apparatus according to an embodiment of the present invention.

FIGS. 5A and 5B are diagrams illustrating automatic registration control of an image forming apparatus according to an embodiment of the present invention.

FIG. 6 is a control flowchart according to a first embodiment.

FIG. 7 is a diagram illustrating an exemplary job according to the first embodiment.

FIG. 8 is a control flowchart according to a second embodiment.

FIG. 9 is a diagram illustrating an exemplary job according to the second embodiment.

### DESCRIPTION OF THE EMBODIMENTS

Hereinafter, various embodiments and aspects of the present invention are described in detail with reference to the attached drawings.

### First Embodiment

### Image Forming Apparatus

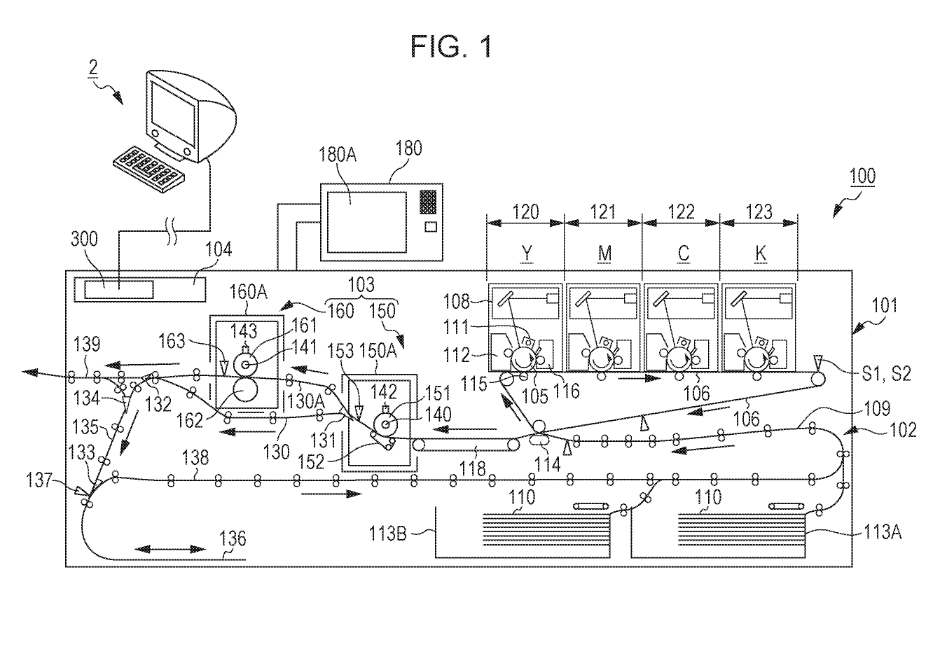

FIG. 1 is a vertical cross-sectional view illustrating a schematic structure of an image forming apparatus 100 according to an embodiment of the present invention. The image forming apparatus 100 is a laser beam printer capable of conducting full color printing (image formation) on a sheet 110 which employs an electrophotographic system as an image formation system.

The image forming apparatus 100 includes a housing (an apparatus main body) 101, and a user interface (an operation unit) 180 provided with a display unit 180A, and the like. Mechanisms constituting an engine unit and a control board container 104 are provided in the housing 101. An engine control unit 300 which controls, for example, each printing process (e.g., a sheet feed process) by each mechanism is held in the control board container 104. A personal computer (PC) 2 as an external host device which. generates a print job is connected to the engine control unit 300 via a network, and the print job is supplied to the engine control unit 300 from the PC 2.

In the engine unit, four image forming stations (toner image forming units) 120, 121, 122 and 123 for forming toner images of four colors of yellow (Y), magenta (M), cyan (C) (the three primary colors of subtractive color mixing), and black (K) are arranged in tandem. An intermediate transfer belt 106 as an intermediate transfer member, a sheet conveyance mechanism unit 102, a fixing process mechanism unit 103 including a first fixing unit 150 and a second fixing unit 160 are also disposed in the engine unit.

The image forming stations 120, 121, 122 and 123 are substantially the same electrophotographic image formation mechanisms which form toner images of different colors as described above. In the present embodiment, each of the electrophotographic image formation mechanisms has a rotary drum-shaped electrophotographic photoconductor (hereafter, “drum”) 105 as an image bearing member, and a process means which acts on the drum. The process means here includes a primary charger 111, a laser scanner 108, a developing unit 112, a primary transfer roller 115, and a drum cleaner 116. For the ease of illustration, reference numerals of these components are not illustrated regarding the image forming stations 121, 122, and 123.

The toner images of Y, M, C and K formed on the respective drums 105 of the image forming stations 120, 121, 122 and 123 are primarily transferred to the intermediate transfer belt 106 in a sequentially registered manner. A full-color (4-color) toner image of Y, M, C and K is formed on the intermediate transfer belt 106. Since the imaging principle, the imaging process, and the imaging operation in each of the image forming stations 120, 121, 122 and 123 are well known, detailed description is omitted.

A sheet 110 is separately fed out of a sheet storage case 113A or 113B as a first or a second container of the sheet conveyance mechanism unit 102. The sheet 110 is guided via a conveyance path 109 into a secondary transfer portion which is a contact portion of the intermediate transfer belt 106 and an external secondary transfer belt 114 as a secondary transfer member (a transfer member) at predetermined control timing. The full-color (4-color) toner image on the intermediate transfer belt 106 is secondarily transferred collectively to the sheet 110.

The sheet 110 is a sheet-shaped material (a medium: a recording material) and may be, for example, regular paper, cardboard, an envelope, a postcard, a label, glossy paper, an OHP sheet, a sheet made of resin, a print sheet, and format paper of various sizes. Hereafter, the sheet may be referred also to as a paper sheet.

In the present embodiment, each of image forming stations 120, 121, 122 and 123, the intermediate transfer belt 106, the external secondary transfer belt 114, and the sheet conveyance mechanism unit 102 are image formation devices that form the toner image on the sheet 110.

The sheet 110 which has left the secondary transfer portion is separated from the intermediate transfer belt 106 and is conveyed to the fixing process mechanism unit 103 by a conveying device 118. The fixing process mechanism 103 in the present embodiment includes the first fixing unit 150 and the second fixing unit 160 which heat and pressurize the toner image secondarily transferred to the sheet 110 in the secondary transfer portion and fix the toner image to the sheet 110.

The first fixing unit 150 includes a fixing roller 151 for applying heat to the sheet 110, a pressing belt 152 for pressing the sheet 110 against the fixing roller 151, and a first fixing sensor 153 for detecting completion of fixing. The fixing roller 151 is a hollow roller provided with a heater 140 inside.

The second fixing unit 160 is located downstream of the first fixing unit 150 in a sheet conveying direction. The second fixing unit 160 applies glossiness to the toner image on the sheet 110 fixed by the first fixing unit 150 or provides fixability. The second fixing unit 160 includes a fixing roller 161, a pressure roller 162, and a second fixing sensor 163. The fixing roller 161 is a hollow roller provided with a heater 141 inside.

That is, in the present embodiment, both the first fixing unit 150 and the second fixing unit 160 are image heating apparatuses each provided with a pair of rotating members for fixing the toner image formed on the sheet 110 with heat and pressure. For example, if it is set to apply a greater amount of glossiness to the sheet 110 or if the sheet 110 requires a greater amount of heat quantity for fixing as in the cardboard, the sheet 110 having passed through the first fixing unit 150 is guided into the second fixing unit 160 via the conveyance path 130A.

The sheet 110 needs not to pass through the second fixing unit 160 depending on the type thereof. In this case, the sheet 110 passes through the conveyance path 130 without passing through the second fixing unit 160. If, for example, the sheet 110 is regular paper or thin paper, and it is not set to apply a greater amount of glossiness to the sheet 110, the sheet 110 having passed through the first fixing unit 150 is conveyed to the conveyance path 130 which bypasses the second fixing unit 160.

Whether the sheet 110 is conveyed to the second fixing unit 160 or the sheet 110 is conveyed bypassing the second fixing unit 160 is determined by switching control of a first flapper 131. A second flapper 132 is a switch-controlled guide member that guides the sheet 110 having passed through the second fixing unit 160 or the sheet 110 conveyed on the conveyance path 130 to a conveyance path 135, or guides the sheet 110 to the discharge path 139 to the outside.

The sheet 110 conveyed on the discharge path 139 is discharged to the outside of the image forming apparatus 100.

An end of the sheet 110 guided to the conveyance path 135 passes through a reverse sensor 137 and is conveyed to a reversing unit (a switchback conveyance path) 136. When the reverse sensor 137 detects a trailing end of the sheet 110, the conveyance direction. of the sheet 110 is switched. A third flapper 133 is a guide member which guides the sheet 110 to a conveyance path 138 for double-sided image formation. When the sheet 110 is guided to the conveyance path 138, the sheet 110 is again guided to the secondary transfer portion via the conveyance path 109, where the toner image is secondarily transferred to the second surface of the reversed sheet 110. Double-sided image formation is thus completed.

A fourth flapper 134 is a (guide member which guides the sheet 110, which has been guided to the conveyance path 135 and then switched back, to the discharge path 139 to the outside. The sheet 110 conveyed on the discharge path 139 is discharged out of the image forming apparatus 100.

In monochrome image formation, an image forming station necessary to form a monochrome image conducts an imaging operation, while other image forming stations conduct no imaging operation with the drums rotating idly.

### Secondary Transfer Portion

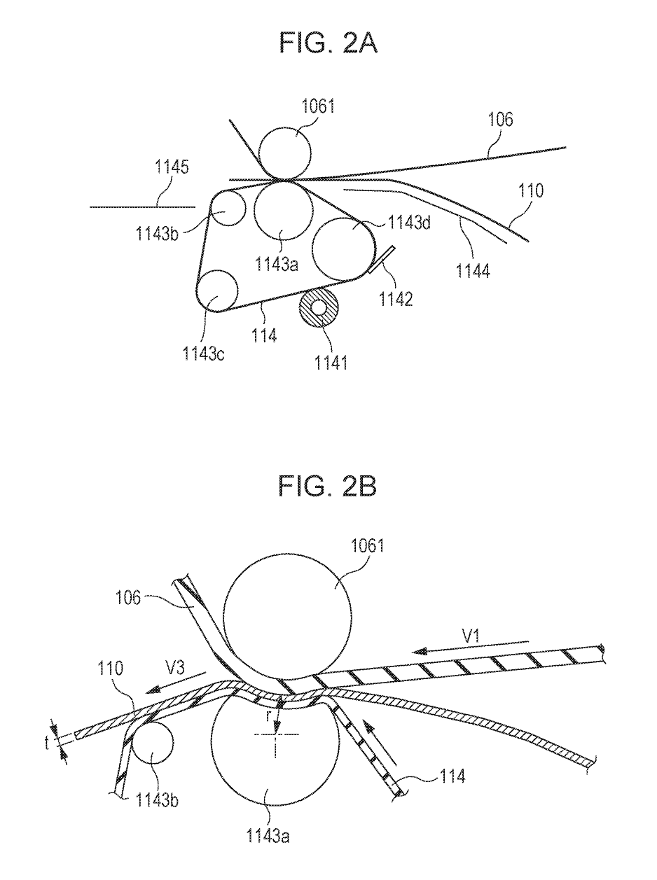

FIG. 2A is an enlarged view of an external secondary transfer belt 114 which is a secondary transfer member in the present embodiment. FIG. 2B is a further enlarged view of FIG. 2A in which r is a curvature radius from the center of an external secondary transfer roller 1143a to a sheet surface, and t is the sheet thickness. When the sheet as the recording medium passes through a transfer nip portion formed between the secondary transfer member and the intermediate transfer member, the toner image primarily transferred to the intermediate transfer member is secondarily transferred to the sheet. Here, in the transfer nip portion, a secondary transfer inner roller 1061 is in contact with the intermediate transfer belt 106 from inside. Predetermined bias is applied to the secondary transfer inner roller 1061.

The external secondary transfer roller 1143a, and tension rollers 1143b, 1143c, and 1143d are in contact with the external secondary transfer belt 114 from inside. The external secondary transfer roller 1143a is grounded electrically. The toner image on the intermediate transfer belt 106 is transferred to the sheet 110 by electrostatic force when a predetermined transfer current is made to flow through the external secondary transfer roller 1143a from the secondary transfer inner roller 1061 via the intermediate transfer belt 106.

A secondary transfer cleaner fur 1141 and a secondary transfer cleaning blade 1142 are provided in an outer periphery of the external secondary transfer belt 114. If toner images of patches for automatic registration control printed on the intermediate transfer belt 106 (described below) or transfer residual toner remaining on the intermediate transfer belt 106 are directly transferred to the external secondary transfer belt 114, these cleaning mechanisms collect toner directly transferred to the external secondary transfer belt 114.

The intermediate transfer belt 106 receives driving force by a later-described driving motor (a first driving source, an intermediate transfer member driving source) M2 and travels at a predetermined surface velocity circumferential speed) V1. The external secondary transfer belt 114 receives driving force by the later-described driving motor (a second driving source independent from the first driving source) M3 and travels at a predetermined surface velocity (a circumferential speed) V2.

The intermediate transfer belt 106 and the external secondary transfer belt 114 may be driven at any speed independently from each other by the driving motor M2 and the driving motor M3, respectively. Therefore, the speed difference (the circumferential speed difference) between V1 and V2 may be reduced to stabilize the geometrical characteristics of the toner image on sheet 110 or, the speed difference (the circumferential speed difference) between V1 and V2 may be provided to improve image transferability (i.e., to reduce image roughness).

Since the surface velocity (the circumferential speed) V1 of the intermediate transfer belt 106 relates to the accuracy in later-described color registration control (the automatic registration control), the surface velocity is controlled highly accurately using an unnillustrated encoder, a high-resolution FPGA control substrate, and the like. However, disturbance torque, such as the surface velocity (the circumferential speed) V2 of the external secondary transfer belt 114 inevitably causes sliding between a driving roller of the intermediate transfer member 106 and an inner circumferential surface of the intermediate transfer member 106.

Although the speed V3 of the sheet 110 should ideally be V1=V3,

since the external secondary transfer belt 114 is driven at a constant speed, a conveyance curvature radius r of the sheet 110 in the secondary transfer portion inevitably varies by the thickness t of the sheet 110.

The sheet 110 arriving at the secondary transfer portion is fed through the conveying path 109 (see FIG. 1) as described above, and is guided by a pre-secondary-transfer guide 1144 (see FIG. 2A) to the secondary transfer portion. The sheet 110 to which the toner image on the intermediate transfer belt 106 having a predetermined circumferential speed difference with the external secondary transfer belt 114 is transferred in the secondary transfer portion is discharged toward a post-secondary-transfer guide 1145 illustrated in FIG. 2A. The sheet 110 is then conveyed by the conveying device 118 (see FIG. 1) to the fixing process mechanism unit 103 (see FIG. 1).

### Block Diagram

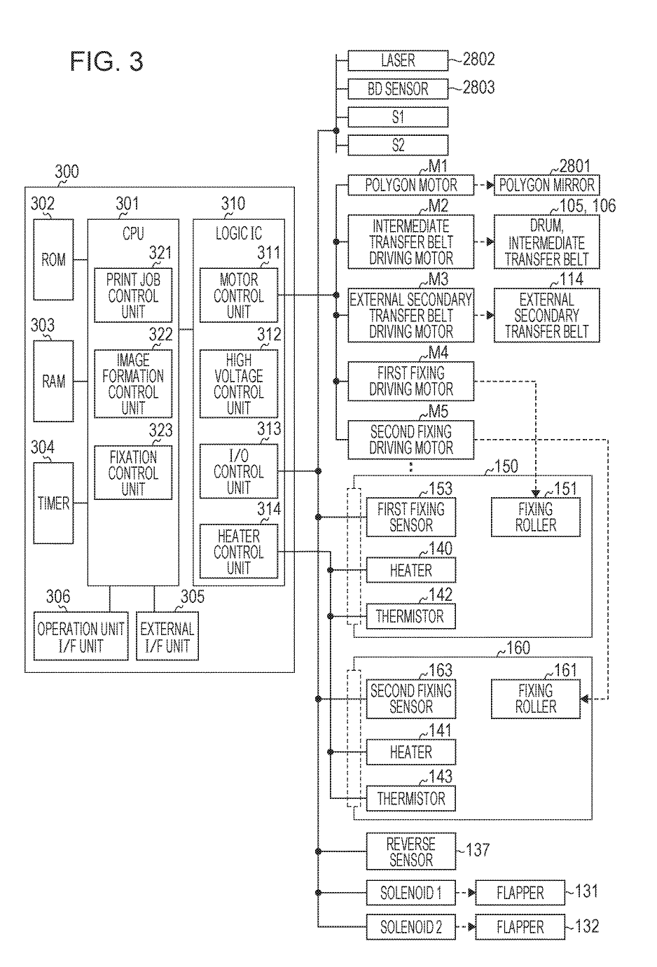

FIG. 3 is a block diagram illustrating a schematic structure of the engine control unit 300 in the present embodiment. The engine control unit 300 includes a CPU 301 which controls the image forming apparatus 100, ROM 302 storing a control program and. data, RAM 303 holding setting values necessary for the control, a timer 304, and an external I/F unit 305 which communicates via a network. The engine control unit 300 further includes an operation unit I/F unit 306 which controls the user interface (the operation unit) 180, and a logic IC 310 provided with various control functions.

In the CPU 301, a print job control unit 321, an image formation control unit 322, and a fixation control unit 323 mainly operate as a program module. The logic IC 310 includes a motor control unit 311 which drives various motors, a high voltage control unit 312 which controls high voltage in development, charging, transfer, and the like, an I/O control unit 313 which controls input and output of various sensors, and a heater control unit 314 which conducts fixing temperature adjustment control.

The motor control unit 311 controls a plurality of motors used in the image forming apparatus 100. A polygon motor M1 drives to rotate a later-described polygon mirror 2801, the intermediate transfer belt driving motor M2 drives to rotate the intermediate transfer belt 106 and the drum 105, and the external secondary transfer belt driving motor M3 drives to rotate the external secondary transfer belt 114. A first fixing driving motor M4 drives to rotate a fixing roller 151, and a second fixing driving motor M5 drives to rotate the fixing roller 161.

Patch sensors S1 and S2, the first fixing sensor 153, the second. fixing sensor 163, the reverse sensor 137, and the like are connected to the I/O control unit 313. Changes in the sensor signals are notified to the CPU 301 via the I/O control unit 313. A laser 2802, a BD sensor 2803, and solenoids 1 and 2 which control flappers 131 and 132 described later are also connected to the I/O control unit 313. Control is conducted by outputting control signals from the I/O control unit 313 in response to an instruction from the CPU 301.

A heater 140 and a thermistor 142 for the first fixing unit 150, and a heater 141 and a thermistor 143 for the second fixing unit 160 are connected to the heater control unit 314. These heaters and thermistors are used for the temperature adjustment control of the first fixing unit 150 and the second fixing unit 160.

### User Interface of Sheet Information Setting

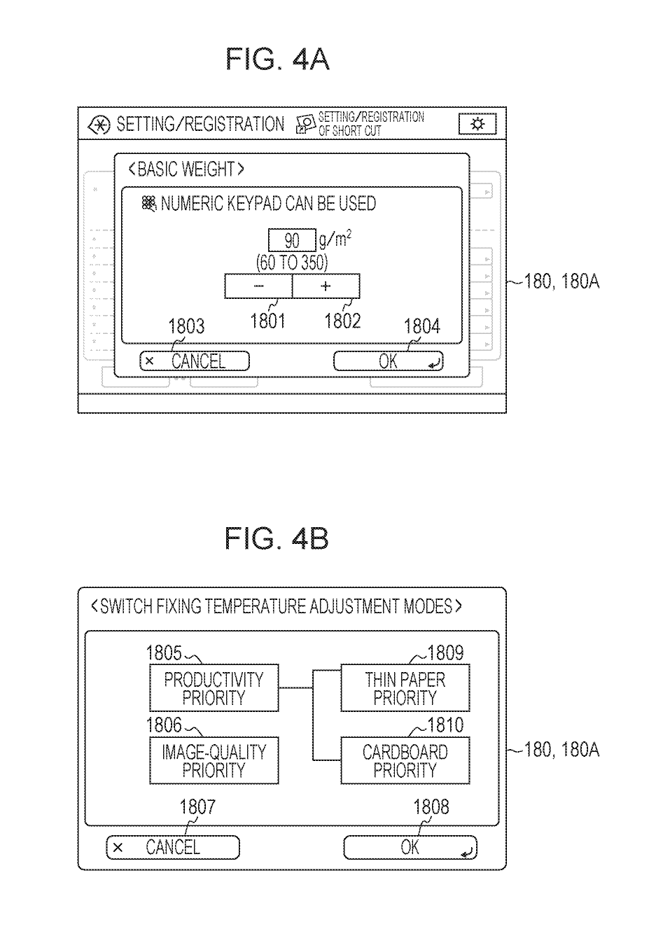

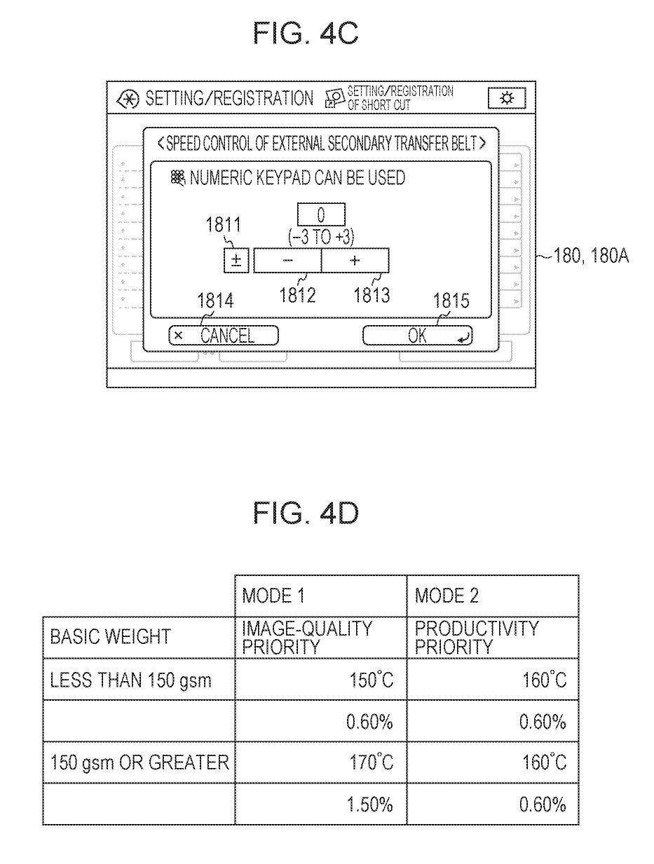

FIGS. 4A to 4D are diagrams illustrating a paper sheet (a sheet) setting screen of the present embodiment. The image forming apparatus 100 of the present embodiment includes the display unit 180A in the user interface (operation unit) 180 (see FIG. 1). The display unit 180A is a touch panel integrated liquid crystal display, on which various types of information (messages) are displayed and various operation buttons (keys) are displayed by the CPU 301. A user may designate print conditions (various settings) and the like using the displayed operation buttons (keys).

Using a screen as an input unit on which information is displayed in the display unit 180A as illustrated in FIGS. 4A, 4B and 4C, the user may arbitrarily set the sheet attributes registered in the RAM 303 of the image forming apparatus 100 on the screens of FIGS. 4A and 4C, and the condition of the job on the screen in FIG. 4B. For example, the basic weight of the sheet may be changed arbitrarily by pressing a (−) key 1801 or a (+) key 1802 on the screen of FIG. 4A. If a change is allowed, the user presses an OK button 1804 and, if not, presses a cancel button 1803.

Using the input unit, the user may associate each of the sheet storage cases 113A and 113B as the first and second containers with either of a first group and a second group about the characteristics of the recording material. The setting is possible in which, if the recording material stored in the container associated with the first group is used for the image formation, a driving source that applies driving force to the secondary transfer belt is driven at a first speed. Further, the setting is possible in which, if the recording material stored in the container associated with the second group is used for the image formation, the driving source is driven at a second speed.

### Automatic Registration Control

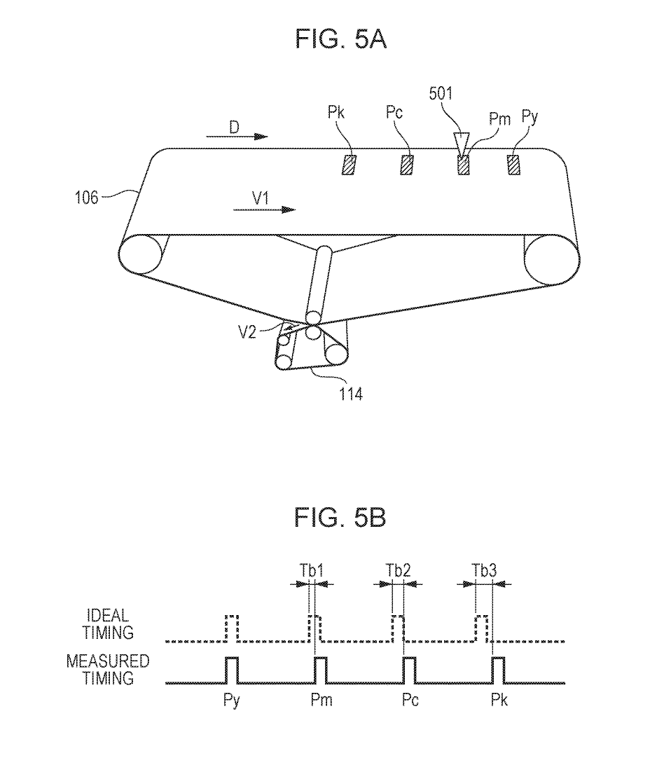

Hereafter, the automatic registration control according to the present embodiment is described with reference to schematic diagrams of the automatic registration control illustrated in FIGS. 5A and 5B. In the present embodiment, a correction operation to correct image misalignment on the basis of a detection result of a test toner image formed on the intermediate transfer member is conducted as the automatic registration control in a period in which no toner image exists in the transfer portion (the secondary transfer portion) (executed by the CPU 301 as an execution unit).

The intermediate transfer member 106 travels at a surface velocity of V1 in the direction of arrow D of FIG. 5A. Regarding the automatic registration control, methods for correcting geometrical characteristics of the image, such as image misalignment, tilt, and main scanning magnification of each image station 120, 121, 122 and 123, are widely known. Here, positional correction among 4 colors of Y, M, C and K in the sub-scanning direction (the traveling direction of the intermediate transfer member 106) is described.

First, each of the laser scanners 108 exposes in each color of Y, M, C and K at time intervals corresponding to the time of drum pitch intervals to form patches Py, Pm, Pc, and Pk of each color on the intermediate transfer member 106. Timing waveforms illustrated in FIG. 5B are acquirable by reading the patches by a sensor 501. Therefore, each of the laser scanners 108 starts exposure with a delay to the time of drum pitch intervals by delays Tb1, Tb2 and Tb3 as gaps with ideal detection timing with respect to the reference color (Y). In this manner, the relative positional relationships between colors on the intermediate transfer member 106 can be brought closer to desired values.

The delays Tb1, Tb2 and Tb3 are obtained by measuring the patches formed on the intermediate transfer member 106. On the basis of the result, registration control of colors among Y, M, C and K is conducted. After generation of the reference color of Y elapses and each time of delays Tb1, Tb2 and Tb3 is added to the time of drum pitch intervals, generation of images of M, C and K is started. That is, by measuring the surface velocity V1 in each state of the intermediate transfer member 106 with the patches, exposure timing is adjusted and relative positions of all the colors of Y, M, C and K is aligned on the intermediate transfer member 106 (the automatic registration control).

The surface velocity of the intermediate transfer member 106 changes with time due to fluctuation in the surface state of the intermediate transfer member 106 or fluctuation in the friction state with the external secondary transfer belt 114. For this reason, when at least changing the driving speed of the external secondary transfer belt 114, the automatic registration control should be conducted.

If the automatic registration control is conducted, a series of control to print the patches of the automatic registration control on the intermediate transfer belt 106, and collect the patches by the external secondary transfer belt 114 and cleaning mechanisms near the external secondary transfer belt 114. This may cause considerably long downtime.

### Image-Quality Priority Mode (Mode 1) and Productivity Priority Mode (Mode 2))

The present embodiment has an image-quality priority mode (mode 1) described. below. In the mode 1, using the input unit, the setting is possible in which, if the recording material stored in the container associated with the first group is used for the image formation, the driving source is driven at the first speed. Further, the setting is possible in which, if the recording material stored in the container associated with the second croup is used for the image formation, the driving source is driven at the second speed. If these settings are made, the control unit determines whether to conduct the correction operation (i.e., the automatic registration control) before conducting the current image formation, depending on the group associated with the container in which the recording material on which the previous image formation is conducted is stored.

The present embodiment also has a productivity priority mode (mode 2) described below. In the mode 2, using the input unit, either of a first setting in which the driving source is driven at a first speed to conduct image formation or a second setting in which the driving source is driven at a second speed to conduct image formation is possible not depending on the group of the recording material stored in the container. If either of the first setting or the second setting is set, the control unit determines whether to conduct the correction operation (the automatic registration control) depending on whether the previous image formation has been conducted.

FIG. 4B is a screen on which job execution is optimized, and is a screen on which fixing temperature adjustment modes are switched. In the image forming apparatus 100 of the present embodiment, several patterns of fixing unit temperature modes may be selected depending on the basic weight of the sheet that can be set on the screen of FIG. 4A.

in a job in which a thin paper sheet and a cardboard sheet are used together, the fixing temperature of the first fixing unit 150 is adjusted to the adjusted temperature (hereafter, “fixing temperature”) to obtain the optimal glossiness (glossy feeling) in each sheet. While the optimal glossiness is obtained, downtime occurs until the fixing temperature becomes a predetermined state (the image-quality priority mode: mode 1). As illustrated in FIG. 4D, in the image-quality priority mode, the fixing temperature is changed depending on the basic weight.

If, however, the job is conducted at a common fixing temperature at which neither of the thin paper sheet nor the cardboard sheet obtains the optimal glossiness but both of them obtain fixability to the extent not to cause a substantial failure, downtime due to switching does not occur although the glossiness is not optimal (the productivity priority mode: mode 2).

In the screen of FIG. 4B, the image-quality priority mode (mode 1) may be selected with an image-quality priority button 1806, and the productivity priority mode (mode 2) may be selected with a productivity priority button 1805. If a change is allowed, the user presses an OK button 1808 and, if not, presses a cancel button 1807.

The image forming apparatus 100 of the present embodiment has a table as illustrated in FIG. 4D in the ROM 302. The table stores the fixing temperatures and circumferential speed differences regarding the basic weight below 150 gsm and the basic weight of 150 gsm or greater in mode 1 (the image-quality priority mode) and mode 2 (the productivity priority mode).

The circumferential speed difference here is an amount obtained by offsetting (the circumferential speed V1 of the intermediate transfer belt 106)/(the circumferential speed V2 of the external secondary transfer belt 114) from 100%. For example, the circumferential speed difference of 1.50% means that the circumferential speed V1 of the intermediate transfer belt 106 is faster by 1.50% than the circumferential speed V2 of the external secondary transfer belt 114.

The present embodiment has a first speed control value and a second speed control value which is greater than the first speed control value in the speed difference with the surface velocity of the intermediate transfer member as speed control values which bring the surface velocity of the secondary transfer member closer to the surface velocity of the intermediate transfer member. Therefore, while producing the circumferential speed difference of 0.6% by the first speed control value, the circumferential speed difference of 1.5% is produced by the second speed control value.

### Control Flowchart According to First Embodiment

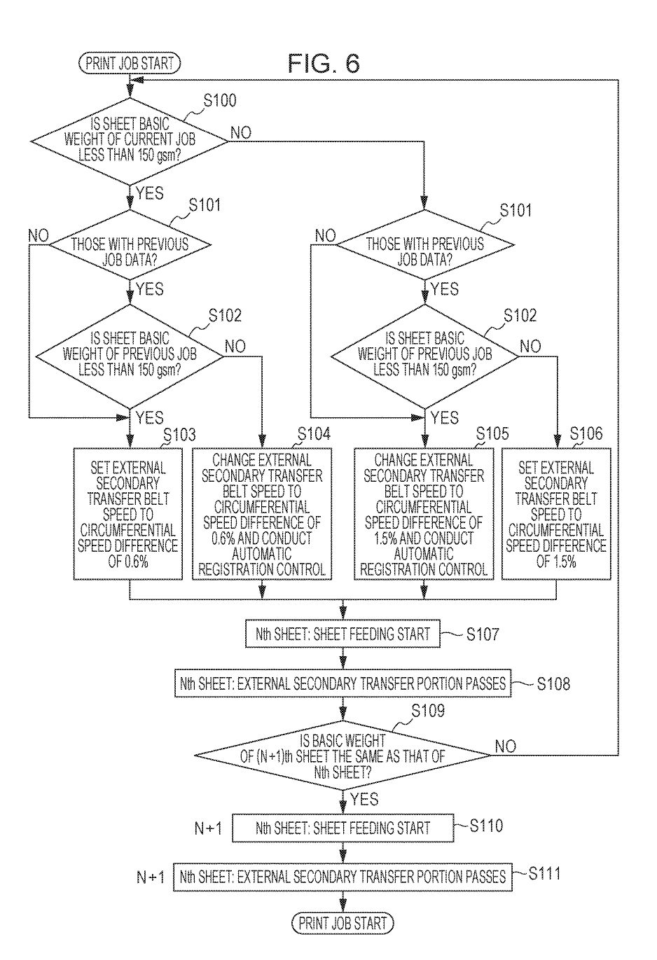

FIG. 6 is a flowchart about selection of speed (switch of speed) of the external secondary transfer belt 114 in the image forming apparatus 100 of the present embodiment provided with the image-quality priority mode (mode 1). This process flow is executed in the CPU 301.

When a print job is started, the set basic weight of the Nth sheet is analyzed (S100), and the analyzed basic weight is compared with the sheet basic weight set in the previous job (S101 to S102). Specifically, a comparison result between a first basic weight (less than the predetermined value) and a second basic weight (the predetermined value or greater) in the current job and the previous job (predetermined. value: 150 gsm) is used in the present embodiment. When the recording medium has the first basic weight, the first speed control value is selected and the circumferential speed difference of 0.6% is produced. When the recording medium has the second basic weight, the second speed control value is selected and the circumferential speed difference of 1.5% is produced.

In a case in which no previous job setting exists (i.e., the current job is the job immediately after the image forming apparatus is started) and the set basic weight in the current job is less than 150 gsm (S103), the external secondary transfer belt 114 is driven at the set speed with the circumferential speed difference of 0.6%. Sheet feeding for printing on the sheet is started without conducting the automatic registration control (S107).

If the sheet basic weight set in the previous job is 150 gsm or greater but the sheet basic weight set in the current job is less than 150 gsm (S104), the set speed of the external secondary transfer belt 114 is changed to have the circumferential speed difference of 0.6%. After conducting the automatic registration control, sheet feeding for printing on the sheet is started (S107).

If the sheet basic weight set in the previous job is less than 150 gsm and the sheet basic right set in the current job is 150 gsm or greater (S105), the set speed of the external secondary transfer belt 114 is changed to have the circumferential speed difference of 1.5%. After conducting the automatic registration control, sheet feeding for printing on the sheet is started (S107).

If the sheet basic weight set in the previous job is 150 gsm or greater and the sheet basic weight set in the current job is also 150 gsm or greater (S106), the external secondary transfer belt 114 is driven at the set speed with the circumferential speed difference of 1.5% (not changed). Sheet feeding for printing on the sheet is started without conducting the automatic registration control (S107).

If the basic weight setting of the (N+1)th sheet differs from that of the Nth sheet (S109), the basic weight setting of the Nth sheet and the basic weight setting of the (N+1)th sheet are compared (S100 to S106). Automatic registration control is conducted as necessary before starting feeding of the (N+1)th sheet, sheet feeding for printing on the (N+1)th sheet is started (S110).

After the sheet feeding, as the sheet 110 passes through the secondary transfer portion at a secondary transfer speed suitable for the setting of the sheet (S111), high definition secondary transfer with a small relative speed difference between the sheet 110 and the intermediate transfer member 106 is conducted and the print job is completed.

### Exemplary Print Job According to First Embodiment

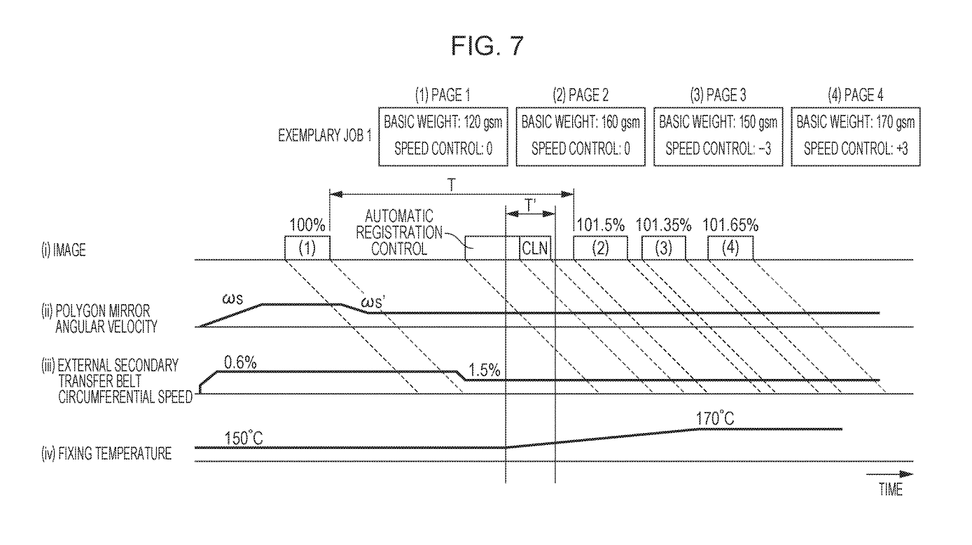

FIG. 7 is a timing chart of an exemplary job printing by the image forming apparatus 100 of the present embodiment. FIG. 7 illustrates exemplary four pages in job example 1 printed sequentially in mode 1 (the image-quality priority mode). On the basis of the table illustrated in FIG. 4D, the polygon mirror 2081 is started at a rotational speed ωs (100.0%), and the external secondary transfer belt 114 is started at the circumferential speed difference of 0.6% to print page 1.

Since the circumferential speed difference is 1.5% in the next page 2, the circumferential speed difference of the external secondary transfer belt 114 is changed to 1.5% after page 1 passes through the secondary transfer portion. Since the load torque applied to the intermediate transfer belt 106 changes due to a change in the circumferential speed of the external secondary transfer belt 114, the automatic registration control needs to be conducted after the circumferential speed of the external secondary transfer belt 114 is chanced. At the same time, the fixing temperature is changed into 170 degrees C. after page 1 passes through the first fixing unit 150. Since it is necessary to start sheet feeding of page 2 after the change in the fixing temperature is stabilized, the automatic registration control is conducted during the waiting time T. Therefore, downtime for the execution of the automatic registration control becomes substantially unnecessary.

Regarding pages 3 and 4, sheets with sheet information setting different from that of page 2 in thickness and surface properties are used together, but the circumferential speed with the circumferential speed difference of 1.5% may be used for both the pages 3 and 4 as the circumferential speed that can maintain the secondary transfer image quality. Therefore, it is not necessary to conduct the automatic registration control again between page 3 and page 4. In the present embodiment, there is a surface velocity difference of 0.9% in the external secondary transfer belt 114 between page 2 and page 3. The sub-scanning magnifications are kept not to change greatly among pages by changing the rotational speed of the polygon mirror 2081 into ωs' to adjust the sub-scanning magnification in printing on the sheet 110.

It is not necessary to selectively use the polygon magnification and the digital magnification in the case in which the sub-scanning magnification is adjusted for each sheet. However, if such a large amount of magnification as 0.9% is applied in the digital magnification, the amount of digital complement for the expansion and contraction of an image becomes large, which may cause more interference fringes and jaggies. For this reason, the polygon magnification or the digital magnification is selectively used depending on the application amount of the changed amount of the speed difference of the external secondary transfer belt 114 in this configuration.

As described above, in mode 1 (the image-quality priority mode), since the circumferential speed of the external secondary transfer belt 114 is selected desirably with respect to image property and the number of times of conducting the automatic registration control can be made as small as possible, productivity of the print job is improved.

As described above, in the image forming apparatus 100 of the present embodiment, since the automatic registration control is not conducted more than necessary and the settings of the speed of the secondary transfer belt suitable for any of the sheets is set, an image forming apparatus with both image property and productivity can be provided.

### Second Embodiment

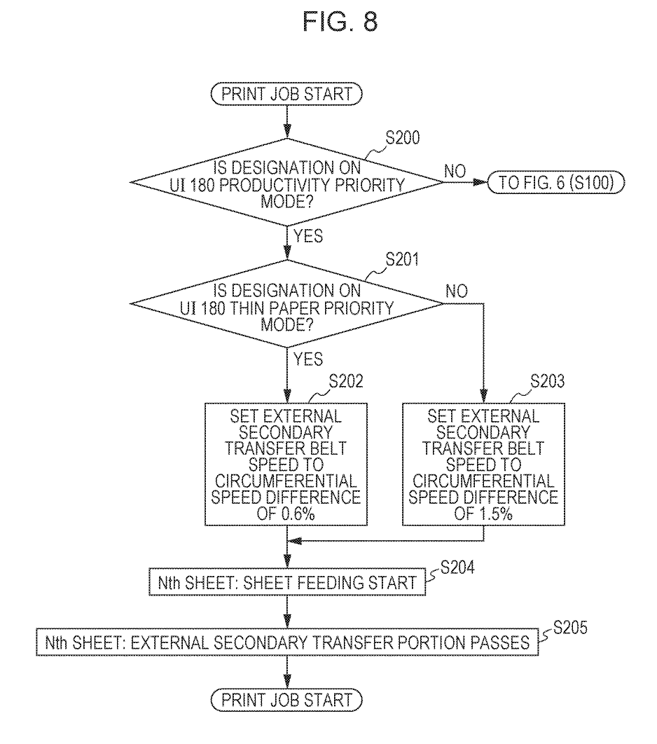

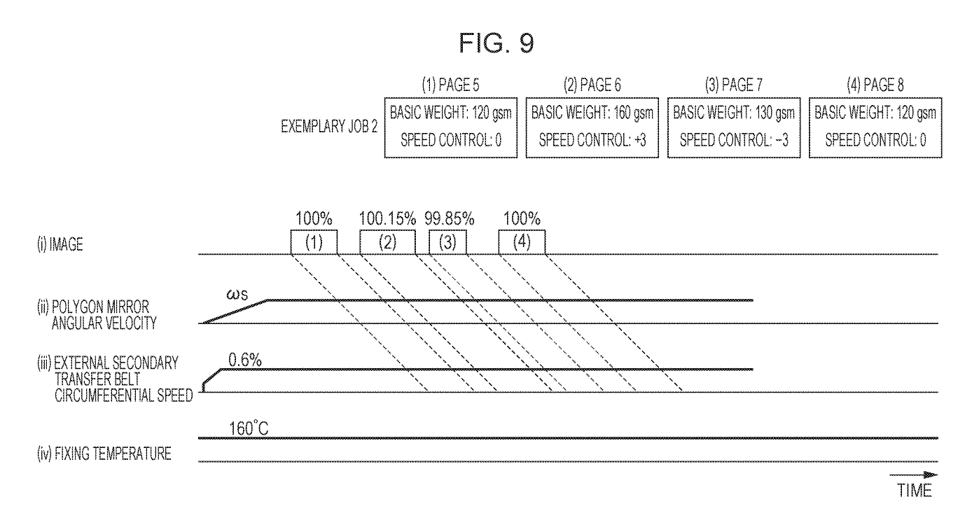

In the present embodiment provided with a productivity priority mode (mode 2), FIG. 8 is a control flowchart of printing four pages illustrated in job example 2 of FIG. 9. This process flow is executed in a CPU 301. When a print job is started, a mode state designated on a user interface an operation unit) 180 is analyzed (S200). If a productivity priority mode is selected, whether a thin paper priority mode or a cardboard priority mode is selected is analyzed (S201).

If the thin paper priority mode is selected (S202), an external secondary transfer belt 114 is driven at a set speed with the circumferential speed difference of 0.6% without conducting the automatic registration control, and sheet feeding for printing on the sheet is started (S204).

If the thin paper priority mode is not selected (i.e., the cardboard priority mode is selected) (S203), the external secondary transfer belt 114 is driven at a set speed with the circumferential speed difference of 1.5% without conducting the automatic registration control, and sheet feeding for printing on the sheet is started (S204).

As described above, in this mode, if the set sheet basic weight of the current image formation differs from the set sheet basic weight of the previous image formation, sheet feeding for printing on a sheet is started without conducting the automatic registration control between sheet feeding events (S204). That is, in this mode, the interface (the operation unit) 180 is provided on which the user may select setting to conduct image formation at either speed of a first speed control value or a second speed control value irrespective of the basic weight of the recording medium.

Next, an exemplary print job of FIG. 9 is described. On the basis of the table illustrated in FIG. 4D, a polygon mirror 2801 is started at a rotational speed ωs, and an external secondary transfer belt 114 is started at the circumferential speed difference of 0.6% to print page 1.

Regarding the next page 2, although the suitable circumferential speed difference of the surface velocity of the external secondary transfer belt 114 is 1.5%, after page 1 passes through the secondary transfer portion, the sheet is fed continuously without changing the speed setting of the external secondary transfer belt 114. Since there is no load fluctuation in the intermediate transfer belt 106 due to a change in the surface velocity of the external secondary transfer belt 114 for each sheet, it is not necessary to conduct the automatic registration control depending on the setting of the sheet basic weight.

As described above, when the user selects mode 2 (a productivity priority mode 1809), middle-level image property, though which is lower than the image quality level obtainable in mode 1 (an image-quality priority mode 1805), and high-level productivity of the image forming apparatus 100 may be obtained.

As described above, in the image forming apparatus 100 of the present embodiment, the user may select between mode 1 (the image-quality priority mode) and mode 2 (the productivity priority mode) depending on the desired image property and productivity. Therefore, an image forming apparatus with high usability can be provided.

In the present embodiment, the fixing temperature in the case in which a recording material has a first basic weight is the same as the fixing temperature in the case in which the recording material has a second basic weight.

### Other Embodiments

Various embodiments and aspects of the present invention have been described, but the present invention is not limited to the same. Various modifications and changes may be made without departing from the scope of the present invention. For example, the image-quality priority mode of the first embodiment and the productivity priority mode of the second embodiment or the third embodiment may be achieved at the same time.

### Other Embodiment 1

Although the surface velocity of the secondary transfer member is considered to be lower than the surface velocity of the intermediate transfer member in the above embodiments, the surface velocity of the secondary transfer member may be considered to be higher than the surface velocity of the intermediate transfer member.

### Other Embodiment 2

Although the external secondary transfer belt 114 is used as the secondary transfer member in the above embodiments, an external secondary transfer roller may be used as the secondary transfer member. In that case, however, since a sheet does not stick to the external secondary transfer roller, it is necessary to maintain the conveyance speed of the sheet at substantially the same as the surface velocity of the intermediate transfer member.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-160540, filed Aug. 17, 2015, which is hereby incorporated by reference herein in its entirety.

What is claimed is:

1. An image forming apparatus, comprising:
a toner image forming unit configured to form a toner image on an intermediate transfer member;
a conveyance member configured to form a transfer portion with the intermediate transfer member via a recording material at which the toner image formed on the intermediate transfer member is transferred to the recording material, and configured to convey the recording material to the transfer portion;
a driving source configured to apply driving force to the conveyance member independently of an intermediate transfer member driving source which applies driving force to the intermediate transfer member;
a correction execution unit configured to execute a correction operation to correct timing at which the toner image is formed on the basis of a detection result of a test toner image formed on the intermediate transfer member in a period in which no toner image exists in the transfer portion;
a plurality of containers in which the recording material to be conveyed to the transfer portion is stored;
an input unit using which an operator makes input to associate each of the plurality of containers and a thickness or a basic weight of the recording material, and
input to set a mode in which, in a continuous image formation job in which formation of toner images on a plurality of recording materials is conducted continuously, the driving source is driven at a speed determined on the basis of a thickness or a basic weight of a recording material used for each image formation event and each image formation event is conducted; and
an execution unit which, if the mode is set, in each image formation event in the continuous image formation job, the driving source is driven at a first speed and image formation is conducted in the case of image formation using a recording material included in a first group, and the driving source is driven at a second speed lower than the first speed and image formation is conducted in the case of image formation using a recording material included in a second group, wherein the execution unit divides each recording material corresponding to the plurality of containers into the first group and the second group so that the thickness or the basic weight of all the recording materials included in the first group are smaller than the thickness or the basic weight of all the recording materials included in the second group and, if the recording material used in the previous image formation and the recording material used in the current image formation are included in the same group, the current image formation is conducted without conducting the correction operation and, if the recording material used in the previous image formation and the recording material used in the current image formation are included in the different groups, the correction operation is conducted before conducting the current image formation, and the current image formation is conducted at timing at which a toner image is formed after the correction.

2. The image forming apparatus according to claim 1, wherein the execution unit sets so that the circumferential speed of the conveyance member when the driving source is driven at the first speed becomes closer to the circumferential speed of the intermediate transfer member than to the circumferential speed of the conveyance member when the driving source is driven at the second speed.

3. The image forming apparatus according to claim 1, further comprising:
a fixing apparatus configured to heat and pressurize a recording material to which a toner image is transferred, and fixes the toner image to the recording material by a fixing member of which temperature is set to a predetermined fixing temperature, wherein
the execution unit sets the fixing temperature to be higher in a case in which the recording material is classified into the second group than the fixing temperature in a case in which the recording material is classified into the first group.

4. The image forming apparatus according to claim 1, wherein the intermediate transfer member is an endless belt member.

5. The image forming apparatus according to claim 1, wherein the conveyance member is an endless belt member.

6. An image forming apparatus, comprising:
a toner image forming unit configured to form a toner image on an intermediate transfer member;
a conveyance member configured to form a transfer portion with the intermediate transfer member via a recording material at which the toner image formed on the intermediate transfer member is transferred to the recording material, and configured to convey the recording material to the transfer portion;
a driving source configured to apply driving force to the conveyance member independently of an intermediate transfer member driving source which applies driving force to the intermediate transfer member;
a plurality of containers in which the recording material to be conveyed to the transfer portion is stored;
an input unit using which an operator makes input to associate each of the plurality of containers and a thickness or a basic weight of the recording material,
input to set a mode in which, in a continuous image formation job in which formation of toner images on a plurality of recording materials is conducted continuously, the driving source is driven at a predetermined speed irrespective of a thickness and a basic weight of a recording material used for each image formation event and each image formation event is conducted, and
input to set, if the mode is set, to either of a plurality of settings including a first setting in which the predetermined speed is set to the first speed and a second setting in which the predetermined speed is set to a second speed lower than the first speed; and
an execution unit which, if the mode is set, drives the driving source at the predetermined speed and executes image formation in each image formation event in the continuous image formation job.

7. The image forming apparatus according to claim 6, wherein the execution unit sets so that the circumferential speed of the conveyance member when the driving source is driven at the first speed becomes closer to the circumferential speed of the intermediate transfer member than to the circumferential speed of the conveyance member when the driving source is driven at the second speed.

8. The image forming apparatus according to claim 6, further comprising:
a fixing apparatus configured to heat and pressurize a recording material to which a toner image is transferred, and fixes the toner image to the recording material by a fixing member of which temperature is set to a predetermined fixing temperature, wherein
the execution unit sets the fixing temperature to a value common to image formation events irrespective of the thickness or the basic weight of the recording material used in each image formation event in the continuous image formation jobs.

9. The image forming apparatus according to claim 6, wherein the intermediate transfer member is an endless belt member.

10. The image forming apparatus according to claim 6, wherein the conveyance member is an endless belt member.

11. An image forming apparatus, comprising:
a toner image forming unit configured to form a toner image on an intermediate transfer member;
a conveyance member configured to form a transfer portion with the intermediate transfer member via a recording material at which the toner image formed on the intermediate transfer member is transferred to the recording material, and configured to convey the recording material to the transfer portion;
a driving source configured to apply driving force to the conveyance member independently of an intermediate transfer member driving source which applies driving force to the intermediate transfer member;
a correction execution unit configured to execute a correction operation to correct timing at which the toner image is formed on the basis of a detection result of a test toner image formed on the intermediate transfer member in a period in which no toner image exists in the transfer portion;
a plurality of containers in which the recording material to be conveyed to the transfer portion is stored;
an input unit using which an operator makes input to associate each of the plurality of containers and a thickness or a basic weight of the recording material, and
an input unit in which, in a continuous image formation job in which a plurality of image formation events are conducted continuously, an operator conducts input for setting a first mode in which the driving source is driven at a speed determined on the basis of a thickness or a basic weight of a recording material used for each image formation event, and conducts each image formation event, and
input for setting a second mode in which the driving source is driven at a predetermined speed not on the basis of the thickness and the basic weight of the recording material used for each image formation event in the continuous image formation job in which a plurality of image formation events are conducted continuously, and conducts each image formation event;
an execution unit which, if the first mode is set, in each image formation event in the continuous image formation job, the driving source is driven at a first speed and image formation is conducted in the case of image formation using a recording material included in a first group, and the driving source is driven at a second speed lower than the first speed and image formation is conducted in the case of image formation using a recording material included in a second group, wherein the execution unit divides each recording material corresponding to the plurality of containers into the first group and the second group so that the thickness or the basic weight of all the recording materials included in the first group are smaller than the thickness or the basic weight of all the recording materials included in the second group and,
if the second mode is set, in the continuous image formation job, the driving source is driven at the predetermined speed and each image formation event is conducted irrespective of the thickness and the basic weight of the recording material used for each image formation event.

12. The image forming apparatus according to claim 11, wherein the intermediate transfer member is an endless belt member.

13. The image forming apparatus according to claim 11, wherein the conveyance member is an endless belt member.
